(19) United States
(12) Patent Application Publication
(10) Pub. No.: US 2026/0217220 A1
(43) Pub. Date: Jul. 30, 2026

(54) Technology for Controlling an Access to a Motor Vehicle With Delegated Key Sharing Having Unambiguous Transfer of Risk

(71) Applicant: Bayerische Motoren Werke Aktiengesellschaft, Muenchen (DE)

(72) Inventor: Matthias FINK, Muenchen (DE)

(21) Appl. No.: 19/432,301

(22) Filed: Dec. 24, 2025

(30) Foreign Application Priority Data
Jan. 24, 2025 (DE) 10 2025 102 582.7

(51) Int. Cl. B60R 25/24

(52) U.S. Cl. CPC B60R 25/24

(57) ABSTRACT

A method for controlling an access to a motor vehicle with delegated key sharing having unambiguous transfer of risk using a detection of service-related digital vehicle keys is provided. In reaction to the detection, access to the motor vehicle using further vehicle keys not related to the service is blocked.

### CROSS REFERENCE TO RELATED APPLICATION

This application claims priority under 35 U.S.C. §119 from German Patent Application No. DE 10 2025 102 582.7, filed January 24, 2025, the entire disclosure of which is herein expressly incorporated by reference.

### BACKGROUND AND SUMMARY

The invention relates to a technology for controlling an access to a motor vehicle, in particular, but not only, by means of digital vehicle keys. The invention is implemented in the motor vehicle, in addition in a service provider server, a vehicle producer server, and an application for, for example, a terminal of an employee of the service provider.

It is known that a digital key can be stored on a terminal, such as a smart phone, for example, in a secure memory of the device. A use of the key is based on interfaces between the secure memory and an operating system of the device, and between the operating system and other applications (“apps”), which are executed on the device.

Thus, the “Car Connectivity Consortium” (CCC) defines, with the “Digital Key Release 3” in the form of a technical specification, a standard for a digital vehicle key. Corresponding digital keys are finding wider and wider use additionally or alternatively to classic vehicle keys such as key fobs.

In this context, for example, an application or app of a vehicle producer, service provider, etc. can be installed, for example, on a terminal, which enables an access to the vehicle, enables a control of specific vehicle functions, etc. by means of the digital vehicle key stored on the device. Expanded usage possibilities additionally result from the presence of a backend system for a key management, i.e., a management of the digital vehicle key.

A digital key or vehicle key can be created, for example, by a coupling of a terminal with a vehicle. In a CCC context, this is called an owner coupling method (“owner pairing”). The condition is that a proof of ownership is provided with respect to the vehicle, for example, by a parallel presentation of two key fobs. A digital key can additionally be forwarded from one device to another (“key sharing”), for example, from one user to another user (for example, in a private application), from a backend to a user (in a commercial server to user application, for example), from a user to a backend (in a so-called service activation as specified by the CCC), or from backend to backend. A terminal or terminals, device producer servers, vehicle producer servers, and the vehicle are incorporated in corresponding signaling, for example, according to the CCC, as well as possibly a service provider server for a server-based key sharing.

If a natural person forwards a digital key to a backend, the key sharing often takes place on the basis of a contract with a service provider. The service provider can be, for example, a repair shop company at which the person wishes to have their vehicle maintained or repaired. The service can generally be provided via a backend, i.e., on one server or by multiple servers. In the example, the backend can offer mechanisms, for example, for a reservation of a repair shop appointment and for digital key sharing, namely so that the repair shop has access to the vehicle during the appointment.

Early CCC specifications defined two rules for digital keys (with regard to their users): the key for the owner or owner key has full or unrestricted rights or authorizations, both with regard to access to the vehicle and also driving the vehicle, and can carry out key sharing in order to share a digital vehicle key for a friend and forward it to the corresponding person (or their terminal). Such granted or forwarded keys generally only have restricted authorizations, for example, only for access to the vehicle (but not driving), or driving only with reduced motor performance, etc. A shared key cannot be shared again.

With release 4, the CCC has introduced an expanded concept for repeated key sharing (“sharing in a chain”), which additionally enables key sharing configurable on multiple levels. Different configuration options can be assigned to a shared key, for example, with regard to key management; for example, a key having corresponding management rights can manage other keys, for example, delete them, even if they were not shared directly or indirectly, or the keys can pass on such management rights. Options with regard to visibility can comprise that one key can see all other keys and not only the keys derived or further shared from this key. Options with respect to a sharing capability can comprise sharing between user accounts or only sharing between various devices of a user account (or no further sharing at all).

Various roles can be defined based on these options, for example, an “owner” can manage all other keys, can further share management rights, can see all other keys, and can share in an unlimited manner. An “administrator” or “admin” can manage all keys except for the owner key, can/cannot further share a management right, can see all other keys, can share in an unlimited manner/only within the account. A member of a “family” can see all other keys, can share in an unlimited manner/limited manner/only within their own account. A “guest” can only share within the account/cannot share at all. A role can also be defined for a service and the service can then act within the rights which were granted to or shared with it. A service could therefore also act in principle as an “administrator”, share with other accounts, etc. Usually, a service can only share within its account or cannot share at all.

A backend which has a key for a vehicle is referred to as an SBOD (“Server Based Owner Device”) or SBFD (“Server Based Friend Device”). An SBOD represents a root element of a key sharing tree and in a certain sense represents an equivalent to a natural person who has carried out an owner coupling with their terminal. An SBOD can be used, for example, for incorporating a vehicle into a vehicle fleet. The SBOD then interacts with a renter or fleet provider for key sharing.

In contrast, an SBFD is shared directly or indirectly by an owner (a natural person or a backend). The SBFD is bound to a service provider which interacts with the SBFD for key sharing. Customers of the service provider can also be incorporated, for example, in a car sharing service, a repair shop, etc.

The procedure of key sharing using a backend is initiated by means of a service activation according to the CCC. An SBxD (SBOD or SBFD) follows the same rules as other digital keys, but an SBxD normally cannot exercise its rights itself (in particular access rights to a vehicle), but rather can only forward or pass on these rights to a shared (granted), forwarded, derived key, etc.

More precisely, SBODs require a proof of ownership for their creation. This can be provided, for example, by a fleet operator in different ways. An SBFD can be implemented by means of regular key sharing (according to standardized CCC protocol) using a backend (service provider and/or vehicle producer). Alternatively, an SBFD service can be created in the backend in reaction to receiving a corresponding request. The processing of the request takes place in a proprietary manner in the backend (depending on the vehicle producer, service provider, etc.). For example, a corresponding request (“service management request”) can be received in a vehicle producer server.

If a customer transfers his or her vehicle to a service provider (e.g., a car dealership, a repair shop, etc.) for repair or maintenance, a transfer of risk takes place, i.e., the vehicle is in an area of responsibility of the service provider from the time of the transfer, and this is the case until the return or delivery of the repaired or maintained vehicle to the customer. If the vehicle is damaged in this period of time, for example, the service provider is responsible.

On the one hand, the service provider has thus taken over the responsibility for the vehicle; on the other hand, however, it in no way has complete control over the vehicle and its status, because the customer or any other person who is in possession of a digital key for the vehicle can access this vehicle according to the authorizations of the respective key, can thus acquire access to the vehicle, and possibly even drive with the vehicle.

Accesses of the customer, of their family members, etc., to the vehicle can actually take place or also only cannot be completely precluded as a possibility. Although the vehicle is in the care of the service provider, the service provider thus cannot ultimately fulfill its responsibility comprehensively and ensure the status or the integrity of the vehicle during the transfer of risk. This already complicates the relationship between the service provider and the customer even below a threshold of an actual damage case, corresponding liability questions, etc., for example, with regard to the contract design, but also with respect to a general trust relationship.

One object underlying the present invention is providing an improved technical concept for a control of an access to a motor vehicle. The invention achieves this object by means of the subjects of the independent claims. Dependent claims reflect preferred embodiments.

A first aspect of the present invention relates to a method for controlling an access to a motor vehicle. The method can be implemented, for example, in the motor vehicle. The method comprises detecting a service-related digital vehicle key; and, in reaction to the detection, blocking an access to the motor vehicle using a further vehicle key not related to the service. The service-related key can have a relationship to a service which is provided by a service provider, such as a repair or maintenance of the motor vehicle which is provided by a car dealership or a repair shop.

The nonservice-related key can be a key of the vehicle owner or another co-user of the motor vehicle, such as a family member, guest, friend, etc. The nonservice-related key can be a digital key, such as an owner key or a key shared directly or indirectly, a key permanently coupled with the motor vehicle, e.g., a key card, smart card, etc., which uses the digital vehicle key. However, the nonservice-related key can likewise be any other nondigital key for the motor vehicle, thus, for example, also a classic key fob, which can also be blocked according to the invention.

Blocking can generally be understood as a (temporary) deactivation or inactivation of an access to the motor vehicle, which can also comprise, however, only partial blocking or a partial blockade or stoppage of access authorizations. The blocking can thus consist of access authorizations of the nonservice-related key not being able to be exercised or not producing their effect in that, for example, a central locking system and/or an immobilizer, etc. of the motor vehicle does not react to the nonservice-related key, thus, for example, starting, activation, or putting a motor into operation in another way does not take place, etc.

The status “blocked” (also referred to herein in short as the “blocked status”) can be physically implemented, i.e., key data are updated to the blocked status, for example in a secure memory in the motor vehicle, terminal, a backend server such as a vehicle producer server, service provider server, etc. Alternatively, the blocked status can also be virtually implemented, wherein the key is not or will not be physically blocked, but rather the blocked status is derived from the physical value and further status information (for example, relating to a SBFD use). Such status information can comprise, for example, access-related information described herein.

Some embodiments of the first aspect of the invention comprise, in reaction to the detection, an assignment to the service of access-related information relating to the blocking. The assignment can comprise an assignment to a technical representation of the service, thus, for example, an assignment to the service-related digital vehicle key as is stored in the motor vehicle, but also an assignment to an SBFD or general SBxD. The information can be provided in the form of a status specification, a tag, an information element, or another indication.

In some of these embodiments, the blocking takes place based on a check of the access-related information. For example, the information can convey an indication or can be interpreted in the vehicle, by a server, etc., so that the service is currently being carried out or the or each service-related key is currently in use. In another example, the information can convey a status “not in execution” or the like of the service or a status “not in use” of the service-related key, etc.

In some embodiments, a check takes place as to whether the detected service-related vehicle key (and/or each further service-related vehicle key) is active. The blocking takes place based on this check and/or the check of the access-related information. If, for example, at least one service-related vehicle key is (still) active, a blockade effect can be maintained.

In some embodiments of the first aspect of the invention, the service-related vehicle key is shared from a server-based service key. Such embodiments comprise, upon a service activation, a storage of the server-based vehicle key in the motor vehicle; and a storage of the service-related vehicle key shared from the server-based vehicle key. In some of these embodiments, in a CCC context, the server-based key can be assigned to an SBFD, which is in turn assigned to a service provider.

Some embodiments of the first aspect of the invention furthermore comprise receiving an indication relating to ending a service execution; and updating the access-related information based on the received indication. The indication can convey, for example, that the vehicle is prepared or ready for a transfer of risk for a return to a holder of the vehicle or a customer of a provided service.

Some of these embodiments furthermore comprise detecting a vehicle key not related to the service; in reaction to the detection, checking the (updated) access-related information; and, based on the check, permitting an access to the motor vehicle using the detected vehicle key not related to the service (implicitly lifting a blockade). Some of these embodiments additionally comprise checking that no service-related vehicle keys are (still) active.

Some of the above-mentioned embodiments additionally comprise a renewed update of the access-related information; the information can represent an indication that the service is not (still) being executed or the or each service-related key is no longer in use.

Some embodiments comprise the further steps of checking whether at least one service-related vehicle key intended for deletion exists; and, if such a vehicle key exists, deleting the existing vehicle key.

A second aspect of the present invention likewise relates to a method for controlling an access to a motor vehicle. The method can be implemented in a backend server, in particular a server which is operated by or for a service provider (“service provider server”, SPS, according to CCC). The method comprises, upon a service activation, generating a server-based vehicle key for the motor vehicle; initiating sharing of a service-related vehicle key from the generated vehicle key (for example, request for a sharing URL); receiving access-related information on the service related to blocking an access to the motor vehicle using a further vehicle key not related to the service; and storing the access-related information in assignment to the service.

Some embodiments of the second aspect of the invention furthermore comprise receiving a request relating to ending a service execution; and, based on the received request, sending a request to assign information to the service which represents that the motor vehicle is ready for a transfer of risk. The request to end the service execution can be received, for example, by an application of the service provider, which is implemented on a terminal of an employee, a PC of the service provider, etc.

Some alternative embodiments furthermore comprise establishing that no service-related vehicle key (230) is active; and, based on the determination, sending a request to assign information to the service that the motor vehicle is ready for a transfer of risk. In these alternatives, for example, a transition into a state “ready for transfer of risk” (implicitly) takes place automatically as soon as no service-related key is still active, i.e., all service-related vehicle keys in the vehicle are deleted or intended for deletion.

A third aspect of the present invention likewise relates to a method for controlling an access to a motor vehicle. The method can be implemented in a backend server, which is operated by a vehicle producer or producer of the motor vehicle, in particular a central vehicle producer server and/or a key tracking server. The method comprises receiving a request with respect to a transfer of risk relating to the motor vehicle; and, based on the received request, sending a request to assign information to the service that the motor vehicle is ready for a transfer of risk.

Embodiments of this aspect of the invention furthermore comprise, upstream, sending a request for sharing of a service-related vehicle key from a server-based vehicle key for the motor vehicle; and/or, downstream, initiating a deletion of all shared service-related vehicle keys.

A fourth aspect of the present invention relates once again to a method for controlling an access to a motor vehicle. The method can be implemented by means of an application which is installed on a terminal of a service provider, for example a terminal or mobile device of an employee, a PC, etc. The method comprises sending a request for sharing a service-related vehicle key from a server-based vehicle key for the motor vehicle; and sending a request relating to ending a service execution, wherein the request comprises assigning information to the service that the motor vehicle is ready for a transfer of risk.

A further aspect of the present invention relates to a computer program product comprising program code sections for carrying out a method according to the fourth aspect of the invention as described herein when the computer program product is executed on a computer. The computer program product can relate to an application or app for a terminal, PC software or a desktop application for a PC or a service terminal, a web application, etc.

Still a further aspect of the invention relates to a terminal, which comprises at least one secure memory for storing a (shared) digital key and also a computer program product or an application as described above.

One aspect of the invention relates to a motor vehicle which is designed to carry out a corresponding method described herein according to the first aspect of the invention.

A further aspect of the present invention relates to a backend server, in particular for a service provider (SPS), which is designed to carry out a corresponding method described herein according to the second aspect of the invention.

Still a further aspect of the present invention relates to a backend server, in particular a central vehicle producer server and/or key tracking server, which is designed to carry out a corresponding method described herein according to the third aspect of the invention.

One aspect of the present invention relates to a system which comprises a motor vehicle as described herein; an application as described herein, or a terminal on which this application is installed; a service provider server as described herein; and a central vehicle producer server and/or key tracking server as described herein. In some embodiments, the service provider server is likewise operated by the vehicle producer.

The invention will now be described in more detail with reference to the appended drawings, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a first exemplary embodiment of a system according to the invention;

FIG. 2 illustrates a second exemplary embodiment of a system according to the invention;

FIG. 3A illustrates a flow chart of a first exemplary embodiment of a method according to the invention;

FIG. 3B illustrates a flow chart of a second exemplary embodiment of a method according to the invention;

FIG. 3C illustrates a flow chart of a third exemplary embodiment of a method according to the invention;

FIG. 3D illustrates a flow chart of a fourth exemplary embodiment of a method according to the invention; and

FIG. 4 illustrates a flow chart of a fifth exemplary embodiment of a method according to the invention.

### DETAILED DESCRIPTION OF THE DRAWINGS

A terminal is to be understood herein as any device at which an electronic communication, a communication network, etc. ends and which is designed for use, operation, etc. by a human user, a person, an operator, a service employee, etc. A terminal can be, for example, a mobile device, a portable device, a wearable, etc., thus, for example, a notebook, tablet, or smart phone, a smart watch, a smart band, a smart ring, etc. Devices for stationary use such as a PC, a service terminal, an operating console, etc. are also viewed as terminals.

When reference is made in short to “a terminal”, this is also to comprise situations in which a terminal having at least one peripheral component is used, thus, for example, a mobile device having a smartcard or other hardware token. A “terminal” can also mean a device which is only available in the future, if it has the required processor capacities, storage capacities, etc. for implementing an aspect according to the invention described herein.

A terminal (or a motor vehicle or a backend server) can have a secure memory or a secured environment, a secured element, etc., for example based on a corresponding chip, a crypto processor, etc. For example, the secure memory can be an HSM (“Hardware Security Module”), a TPM (“Trusted Platform Module”), a secured element (“Secure Element”, “Secure Enclave”), a TEE (“Trusted Execution Environment”) etc. A secure memory can be designed to store or save at least one cryptographic, electronic, or digital key. For example, a secure memory can be designed to store at least one cryptographic or digital vehicle key, wherein the latter can be stored, for example, in the form of an endpoint according to CCC.

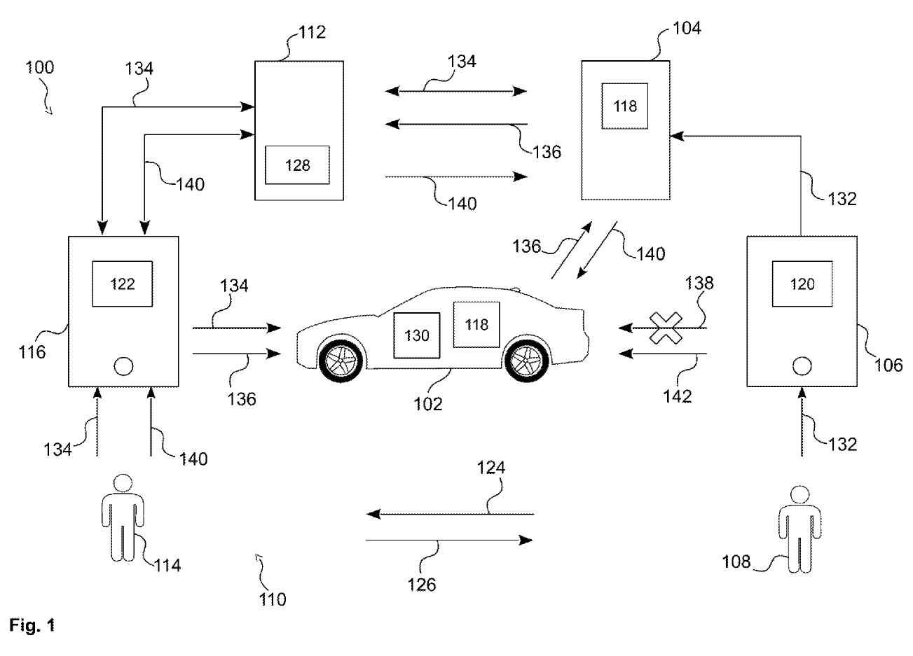

FIG. 1 shows in schematic form a system 100 having a motor vehicle 102, a server 104 in a backend for the vehicle 102, and a terminal 106 of a user 108 of the vehicle 102. A service provider 110 operates a service provider server 112. An employee 114 uses a terminal 116 provided by the service provider 110.

It is assumed of the user 108 for the sake of clarity that he or she is the possessor or owner of the vehicle 102. In addition, he or she is a customer of the service provider 110, and therefore for the sake of clarity reference is sometimes made to the owner 108 of the vehicle or to the customer 108 of the service provider, and this means the same person.

The owner 108 has a digital vehicle key 118 for the vehicle 102, wherein a counterpart of the owner key 118 is stored in each case in the vehicle 102 and in the terminal 106 (not indicated there) of the owner 108; the details are familiar to a person skilled in the art. In other exemplary embodiments, the user 108 can also be any other authorized person, thus, for example, a spouse of the owner, etc., and the digital vehicle key 118 could be a key derived from the owner key, an administrator key, etc.

The reference sign “104” is used hereinafter both to designate in general a or the backend 104 for the vehicle 102 and is also used to specifically designate the server 104, which can be operated, for example, by a producer of the vehicle 102. In a CCC context, the server 104 can comprise, for example, a central vehicle producer server (“vehicle OEM server”, OEM = “Original Equipment Manufacturer”) and/or a key tracking server (KTS) for a backend-side or vehicle-side key management.

An application 120 for a device-side key management is installed on the terminal 106 of the vehicle owner 108, for example, a vehicle support app offered for this purpose by the vehicle producer.

The service provider 110 is in this example intended to be a repair shop company. The “service provider server” 112 can be operated either by the service provider 110 itself or by the vehicle producer, which also operates the server 104. The employee 114 can work as an auto mechanic, automotive mechatronics engineer, automotive service technician, etc. for the service provider 110. The terminal 116 provided by the service provider 110 can be, for example, a smart phone, on which a service application or service app 122 for a repair shop-related key management is installed.

As stated, the vehicle owner 108 is a customer of the service provider 110 and gives them an order for a repair or maintenance of the vehicle 102. For the processing of the order, a transfer of the vehicle 102 by the owner 108 to the service provider 110 is necessary. This includes a transfer of risk 124 relating to the vehicle 102 from the owner 108 to the service provider 110. This means, for example, that the service provider 110 is liable from the time of the transfer for damage to the vehicle 102, which is caused, for example, by employees of the service provider 110, such as the employee 114.

In turn, the service provider 110 is to have complete or sole control of the vehicle 102. However, this is not the case because the owner 108 can still acquire access to the vehicle 102 using his or her owner key 118, and likewise all possessors or users of derived or shared digital vehicle keys and also other keys assigned to the vehicle 102 (classic key fobs, digital keys in the form of hardware tokens (for example, smart cards, etc.)). Damage situations can therefore occur in which a responsibility is not established with absolute clarity, and the theoretical possibility that such situations could occur alone is already unsatisfactory for service provider and customer.

Therefore, technical measures are proposed according to the invention, using which it is ensured that after the transfer of risk 124 and until a return 126 of the vehicle 102 to the owner 108, all digital keys for the vehicle 102 which are outside an area of responsibility of the service provider 110 are blocked or disabled. More precisely, an SBFD 128 is present in the service provider server 112, and, for example, a service provider key 130 is derived therefrom. Only this and further keys derived from the SBFD 128 obtain access to the vehicle 102, and all other keys are blocked. These measures take effect as soon as the service provider 110 (in the example, the employee 116) specifically accepts the vehicle 102. This can already be the case in that the employee 116 re-parks the vehicle 102 on premises of the service provider 110 after the transfer 124.

As stated, it is proposed according to the invention that the blocked keys (including the owner key 116) remain blocked until the service provider 110 has completed the ordered task, more precisely, until (in the example) the employee 116 has declared the work on the vehicle to be completed by means of the service app 122. This can also include, for example, a movement of the vehicle 102 to a transfer point at which the owner 108 can take receipt of the vehicle 102 again (renewed transfer of risk).

In detail, the owner 108 arranges a corresponding service activation 132 in one step (or an action, operation, procedure, etc.), for example via the app 120 (or a separate app of the service provider 110, which could likewise be installed on the terminal 106). As a result of the service activation 132, the virtual or server-based “friend device” or SBFD 128 is instantiated on the service provider server 112. In this way, rights for key sharing are delegated to the service provider 110 and an SBFD service key is created in the backend 112. This is also transferred to the vehicle 102, as with regular digital keys which are shared, for example, between smart phones.

The owner 108 brings the vehicle 102, for example, to a premises at the agreed repair shop appointment and transfers (procedure 124) the vehicle 102 to the service provider 110. The vehicle 102 is now located in the area of influence of the service provider 110 and the employee 116 can implement the vehicle at any time, begin with repair or maintenance work, etc.

For an access to the vehicle 102, the service provider 110 requests a key release from the SBFD (or the key management service implemented thereby) 128. An employee of the service provider 110 could effectuate this, for example, at a PC, service terminal, etc. However, in the example illustrated in FIG. 1, the employee 116 requests key sharing 134 by means of the service app 122 on his or her terminal 116, which as a result leads to the storage of the key 130 shared (indirectly) from the key 118 on the terminal 116 and in the vehicle 102 (the shared key 130 is designated hereinafter for the sake of clarity as a “service provider key” 130 and is only indicated in the vehicle 102 in FIG. 1).

As soon as the service provider key 130 on the terminal 116 of the employee 114 comes into contact with the vehicle 102 during a procedure 136, the vehicle 102 marks or identifies the SBFD service 128, provides, for example, the service 128 with an indication that the service 128 is “being performed” or the service provider key 130 is “in use” or “in employment”, etc. This indication (for example, in the form of a tag having a corresponding value or information content) is used to block all keys which are not derived from the SBFD service 128. Access attempts of the owner key 118 are thus blocked, as are access attempts of all other keys derived directly or indirectly from the key 116 (except for the SBFD 128), as well as all other non-digital keys such as key fobs, etc. This means, for example, access attempts of digital keys which are issued at the factory, for example, in the form of smart cards, etc. are also rejected.

As a specific example, it is indicated in FIG. 1 that the vehicle owner 108 undertakes an access attempt 138 on the vehicle 102 by means of his or her terminal 106 and vehicle support app 120 using the owner key 118, wherein this attempt fails, i.e. the vehicle 102 does not allow access. Which access rights are specifically allowed and which are rejected or blocked can be configurable. In general, an access can be solely restricted to the vehicle 102 not being able to be driven or moved, or can include that an access to the vehicle 102 is also blocked.

As soon as the work on the vehicle 102 is completed, the employee 114 can specify this accordingly in a procedure 140, for example by means of the service app 122. This causes all keys shared by the SBFD service 128 to be deleted. More precisely, the procedure 140 can trigger a multistep sequence up to the return of the vehicle 102 to the owner 108. For example, an indication or information can be stored in the service provider server 112 which represents the circumstance that the task connected to the SBFD 126 is processed, thus, for example, a task status is “ready for transfer (of risk)”, and that the derived key 130 is intended for deletion. The task status of the SBFD service 128 in the server 112 can also depend in detail on further influences, for example, the status can change when the owner 108 has paid his or her invoice, etc.

A deletion of the shared key 132 can either take place immediately, or it can take place as a multistage deletion (“soft delete”), i.e. it can take place in multiple stages or steps. In this case, an active key initially changes to the status “extended” or “intended for deletion” (“pre-deleted”), or the like, wherein all authorizations conveyed by the key are still retained. Such a multistage deletion is known as such for a deletion of digital keys via wallet or backend and is typically preferred if, for example, the state of the relevant vehicle is not immediately known. For example, the person to whom the key to be deleted is assigned could be driving the vehicle at that moment.

The return 126 of the vehicle 102 to the owner 108, and therefore the corresponding transfer of risk, technically means that upon approach 142 of the customer 108 (or the owner key 118 in the terminal 106), the task status assigned to the SBFD service 128 is reset from “ready for transfer” to “not in processing” or “not in use” or the like. As a result, the temporary blockade of the owner key 118 is lifted, i.e. the access of the user 108 to the vehicle 102 by means of the key 118 is again provided as usual, i.e. as before the transfer 124 of the vehicle to the service provider 110. This also applies for all keys derived from the owner key 118, keys assigned to the vehicle 102 at the factory, etc.

With a soft delete of the keys derived from the SBFD 128 (including service provider key 130), in addition the actual deletion of these keys is triggered by the approach 142 of the customer 108.

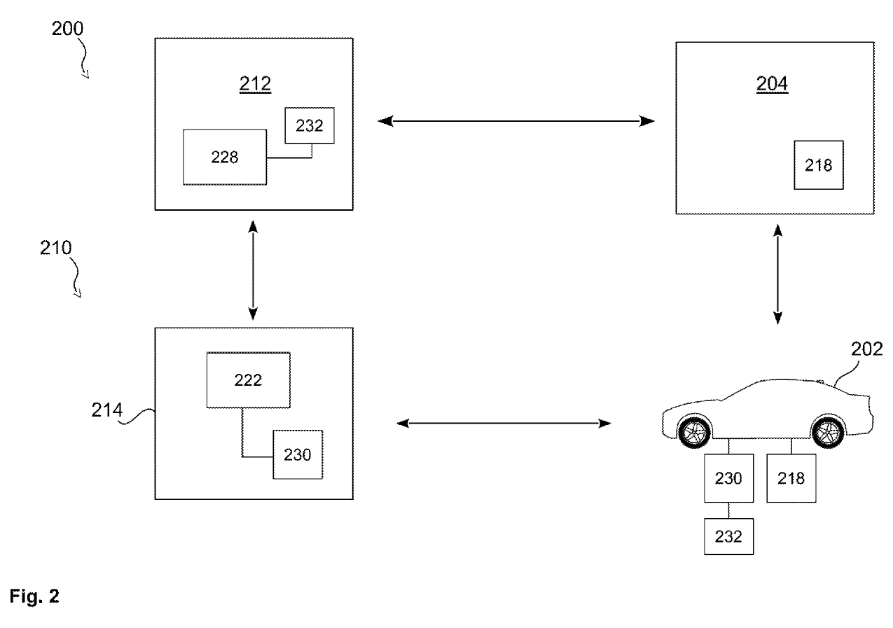

FIG. 2 shows, in the form of a schematic block diagram, a further exemplary embodiment of a system 200 having a motor vehicle 202, a server 204 in a producer-side backend for the vehicle 202, a service-side backend server 212, and a service-side terminal 216.

The functionality of the motor vehicle 202 described hereinafter can be provided by means of an ECU (“electronic control unit”) or a system of multiple ECUs of the vehicle 202. An owner key 218, and at least temporarily a shared service provider key 230, as described hereinafter, are held in the vehicle 202.

A counterpart to the service provider key 230 in the vehicle 202 is present in the terminal 214 (indicated with the same reference sign), and in the service provider server 212 (not indicated). An SBFD 228 is present in the service provider server 212, to which a status (status-related information) 232 is assigned. This status 232 is likewise represented in the vehicle 202, which is assigned to the service provider key 230 here as an abbreviation for the sake of clarity.

A service app 222 of the service provider 210 is installed in the terminal 214.

The components of the system 200 shown in FIG. 2 interact to control an access to the vehicle 202 in a manner according to the invention, specifically in particular while the vehicle 202 is located in an area of influence or responsibility of the service provider 210, for example while this service provider provides a service on the vehicle 202.

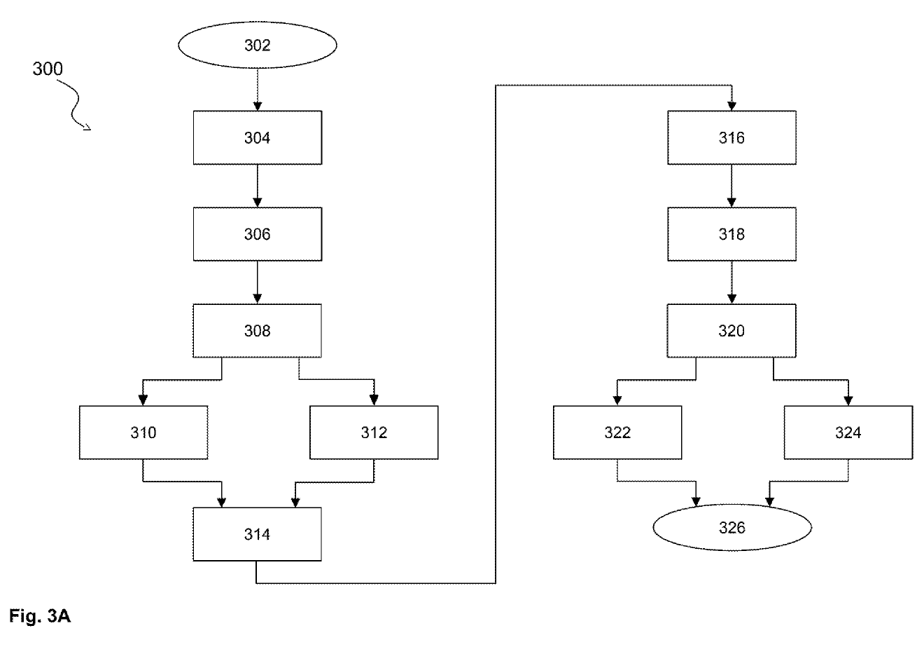

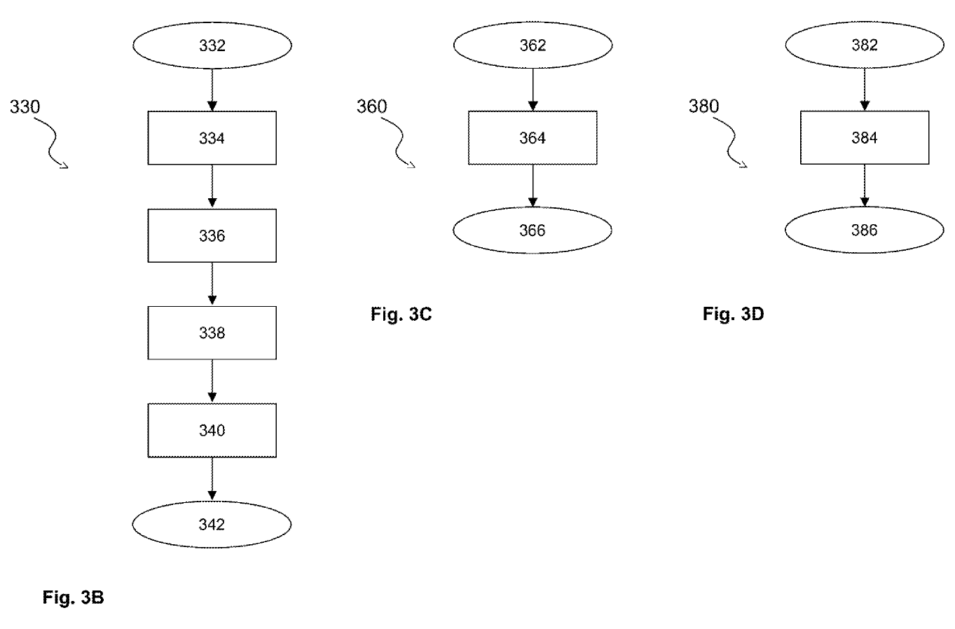

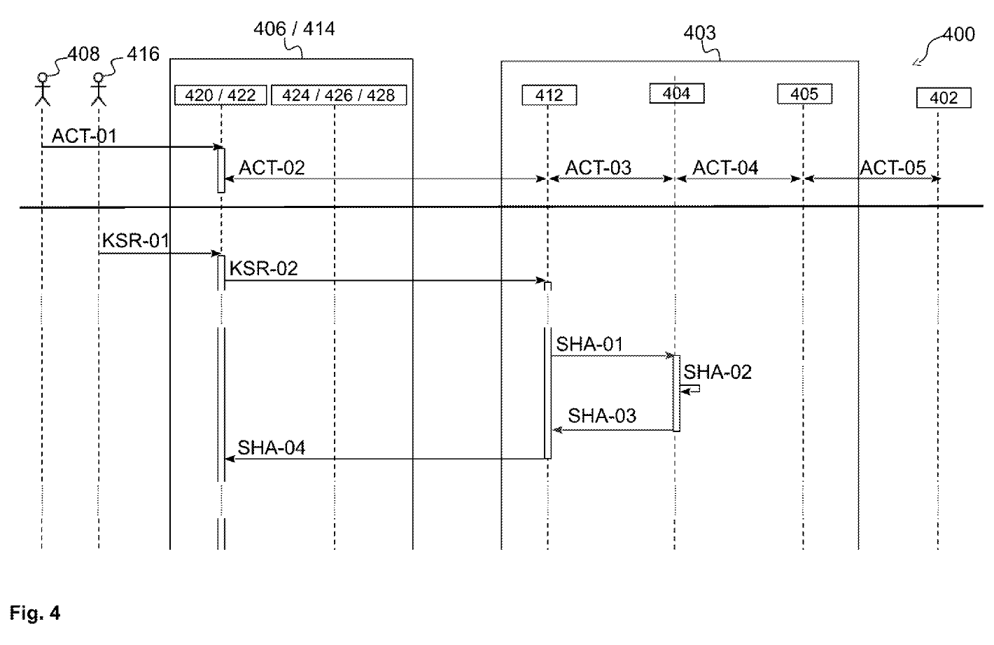

A specific sequence for a corresponding key sharing in the system 200 will be described in more detail hereinafter with reference to the sequences schematically shown in FIGS. 3A, 3B, 3C and 3D. In this case, FIG. 3A shows a sequence of a method 300 for controlling an access to the motor vehicle 202 in the motor vehicle 202. FIG. 3B shows a sequence of a corresponding method 330 in the service provider server 212. FIG. 3C shows a sequence of a corresponding method 360 in the vehicle producer server 204. FIG. 3D shows a sequence of a corresponding method 380 in the receiver device 214.

A sequence begins in the method 330 in FIG. 3B in a step 332, with a service activation, in that a generation of a server-based vehicle key (SBFD 228) for the motor vehicle 202 is initiated. In a corresponding step 302 in method 300 in FIG. 3A, a counterpart of the server-based vehicle key is stored in the motor vehicle 202 (not indicated in FIG. 2).

In a step 382 (method 380 in FIG. 3D), the terminal 214 sends a request for sharing of the service-related vehicle key 230 from the server-based vehicle key (SBFD 228). In a corresponding step 334 (method 330 in FIG. 3B), the service provider server 212 thereupon initiates sharing of the service-related vehicle key 230 from the server-based vehicle key. In a corresponding step 304 (method 300 in FIG. 3A), the service-related vehicle key 230 is stored in the vehicle 202.

In a step 306, the vehicle 202 detects the service-related digital vehicle key 230 stored in the terminal 214, for example because the terminal 214 is located in the vicinity of the vehicle 202. In reaction to the detection, the vehicle 202 assigns access-related status information 232 to the SBFD service 228 or the service-related vehicle key 230. The status information 232 can represent, for example, that the service 228 is currently being carried out or that the service-related vehicle key 230 is being used. In a corresponding step 336 (method 330 in FIG. 3B), the service provider server 212 receives the access-related status information 232 from the vehicle 202 (for example, via the vehicle-related backend 204) and stores this information in a step 338 in assignment to the SBFD 228.

In a step 314 (method 300 in FIG. 3A), the vehicle 202 blocks an access or access attempt to the motor vehicle 202 using the vehicle key 218 not related to the service 228. The blocked access can relate to an access to the motor vehicle 202 and/or driving of the motor vehicle 202. The blocking can take place based on a check of the access-related information 232 carried out in an optional step 310. If the information 232 indicates that the service-related key 230 is in use or the service linked with the SBFD 228 is being carried out, the key 218 is blocked in the exercise of its access rights.

Additionally or alternatively, the blocking in step 314 can take place based on a check carried out in a step 312 as to whether the service-related vehicle key 230 (and/or any other or further service-related vehicle key) is active. Steps 310 and 312 can take place in parallel or in succession. It is also conceivable that instead of steps 310, 312 as described here, alternatively or additionally other steps are carried out, on the basis of which the blocking of the access takes place in step 314.

In a step 384 (method 380 in FIG. 3D), the terminal 214 sends a request relating to ending the performance of the service which is linked with the SBFD 228. The request comprises assigning status information 232 to the service, which indicates that the motor vehicle 202 is ready for a transfer of risk, thus a return to the owner, possessor, etc.

In a corresponding step 340 (method 330 in FIG. 3B), the service provider server 212 receives the request relating to the ending of the service performance from the terminal 214. Based on the received request (and possibly after further requests have been fulfilled, such as payment of an invoice by the vehicle owner, etc.), the service provider server 212 sends a request in a step 342 to assign the corresponding status information 232 to the service that the motor vehicle 202 is ready for a transfer of risk. In an alternative exemplary embodiment, step 340 comprises establishing that the service-related vehicle key 230 is no longer active. Based on the establishment, the service provider server 212 sends the request in step 342 to assign the corresponding status information 232 to the service that the motor vehicle 202 is ready for a transfer of risk.

The sequence specific to the invention is thus ended in the server 212, regardless of whether a sequence known per se with respect to the SBFD 228 comprises further steps.

In a corresponding step 362 (method 360 in FIG. 3B), the vehicle producer server 204 receives the request with respect to the transfer of risk relating to the motor vehicle 202. Based on the received request, the server 204 sends a request to the vehicle 202 in a step 364 to assign status information 232 to the service 228 or the service provider key 230, which indicates that the motor vehicle 202 is ready for the transfer of risk. In a parallel or following step 366, the server 204 initiates a deletion of all shared service-related vehicle keys including the key 230. The sequence specific to the invention is thus ended in the server 204.

In a corresponding step 316 (method 300 in FIG. 3A), the vehicle 202 receives the indication relating to the ending of the service performance, and in a step 318 updates the access-related status information 232 accordingly based on the received indication. In particular, the updated information 232 indicates that the motor vehicle 202 is ready for a transfer of risk.

In a step 320, the vehicle 202 detects the nonservice-related key 218. The vehicle 202 thereupon checks, in a step 322, the current status information on the SBFD service 228 (which indicates after step 318 that the vehicle 202 is ready for a transfer). In a parallel step 324, the checking can also comprise a check that no service-related vehicle key (such as the key 230) is still active. If the check has a positive result, the vehicle 202 permits the access to the motor vehicle 202 using the detected vehicle key 218 in a step 326. The sequence specific to the invention is thus ended in the service provider server 212.

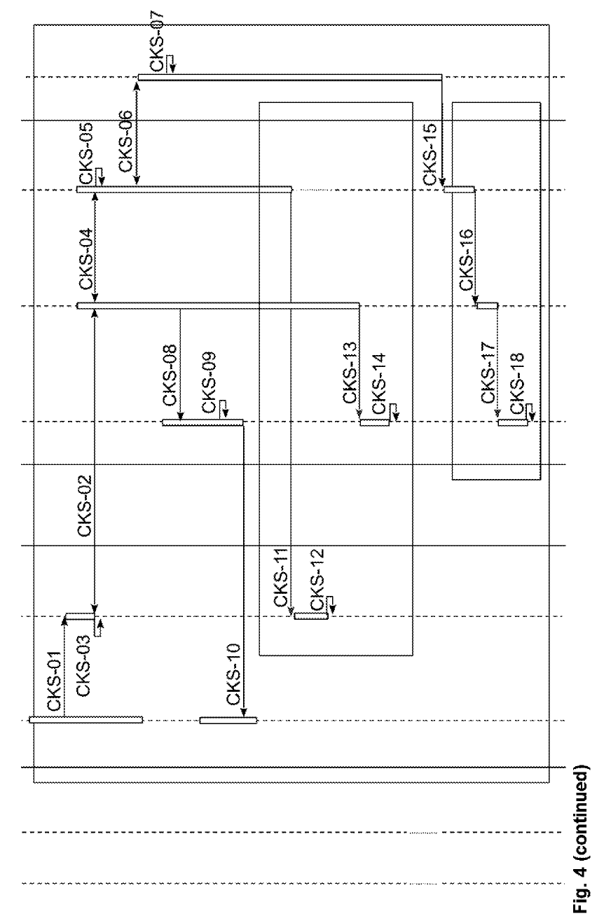

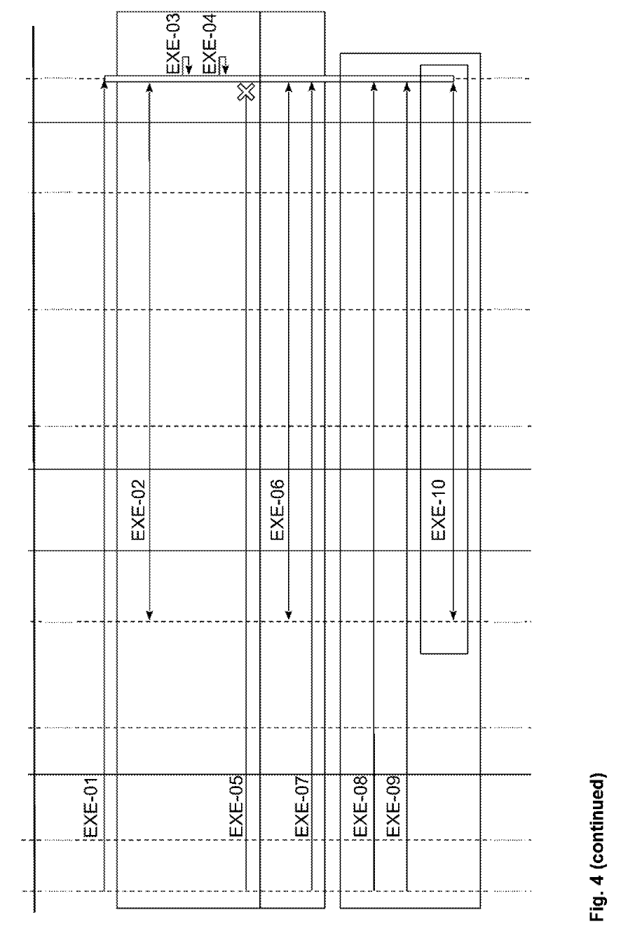

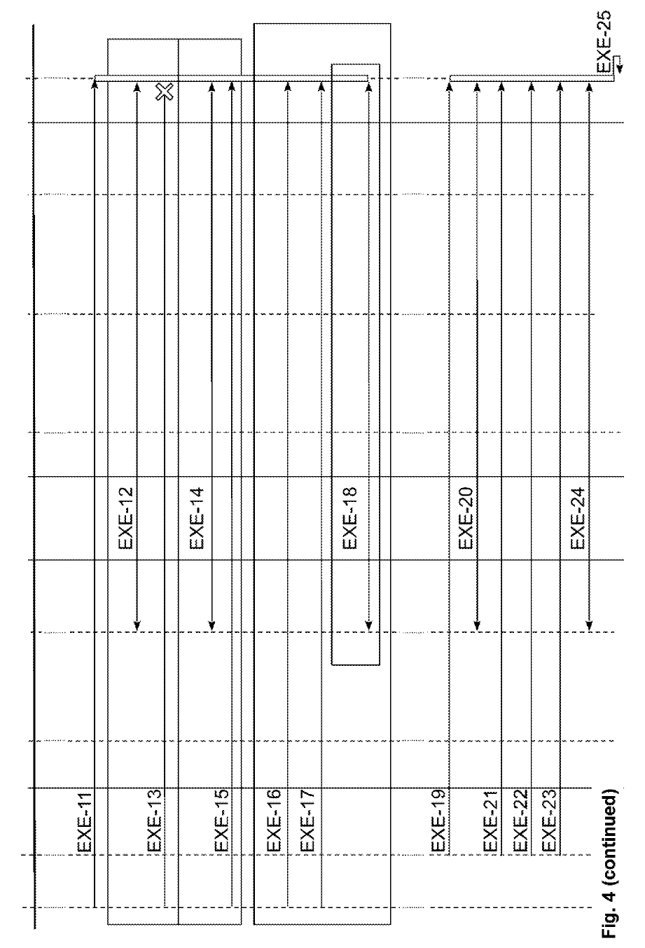

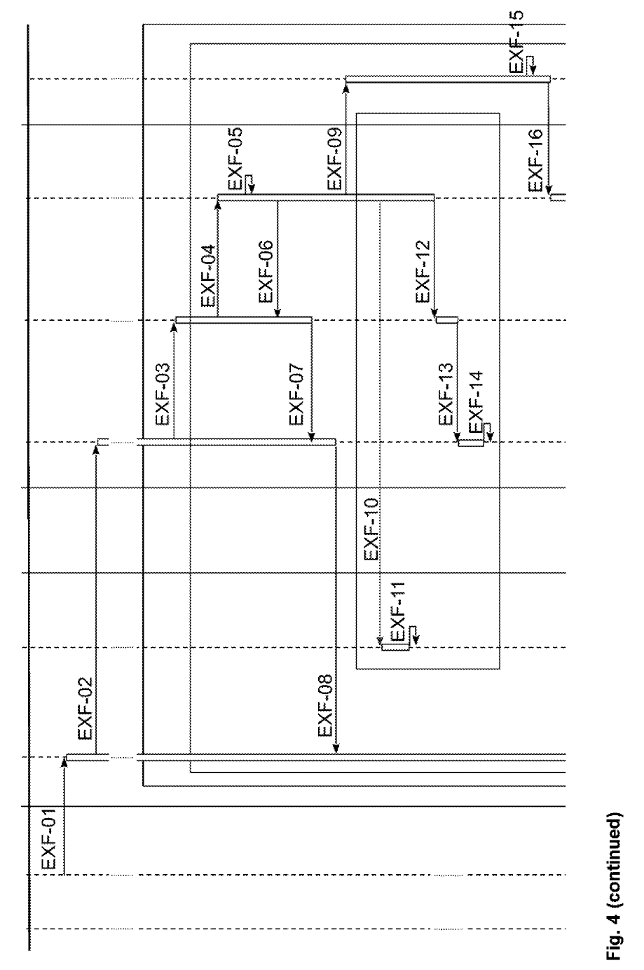

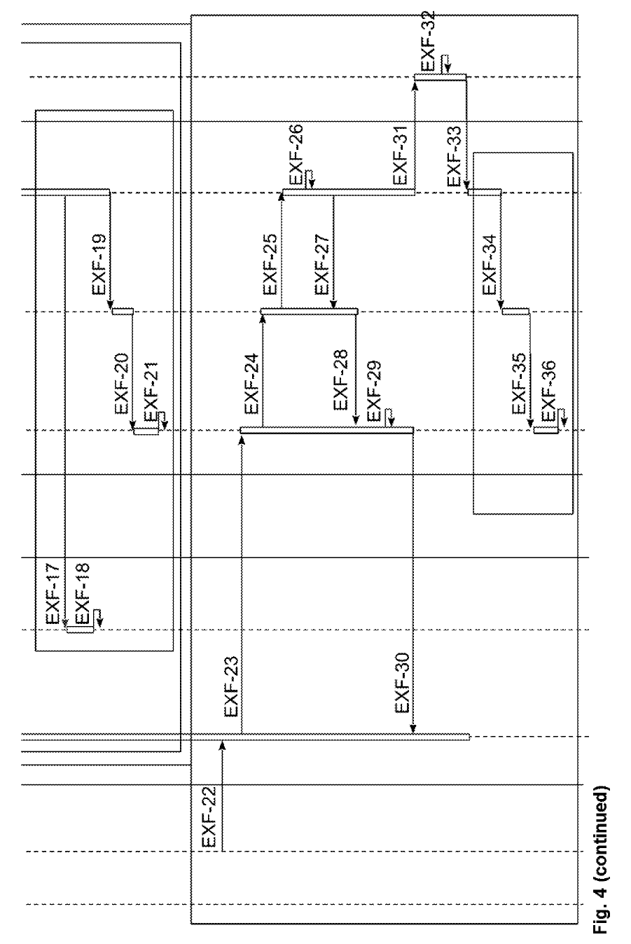

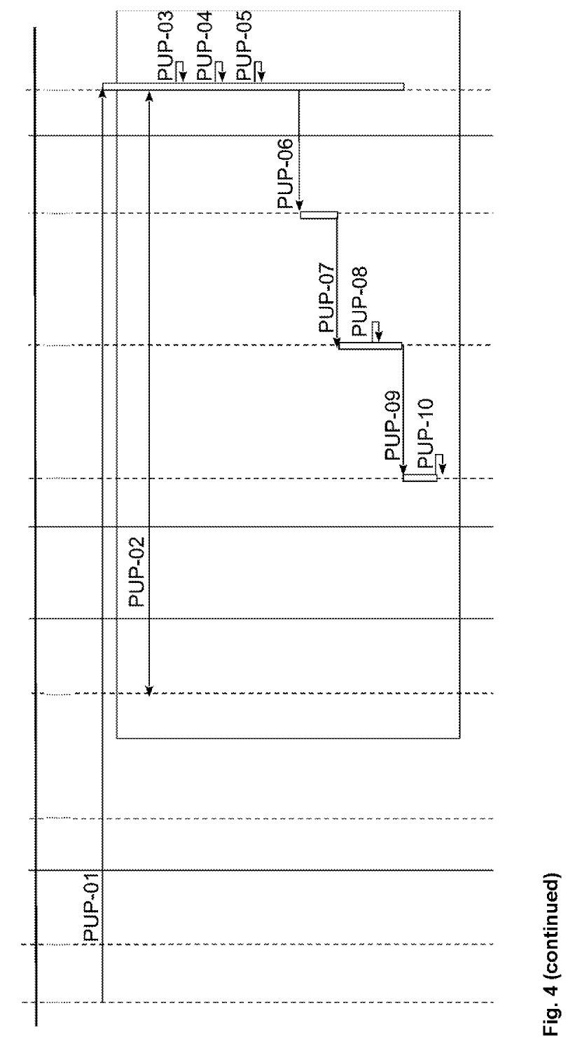

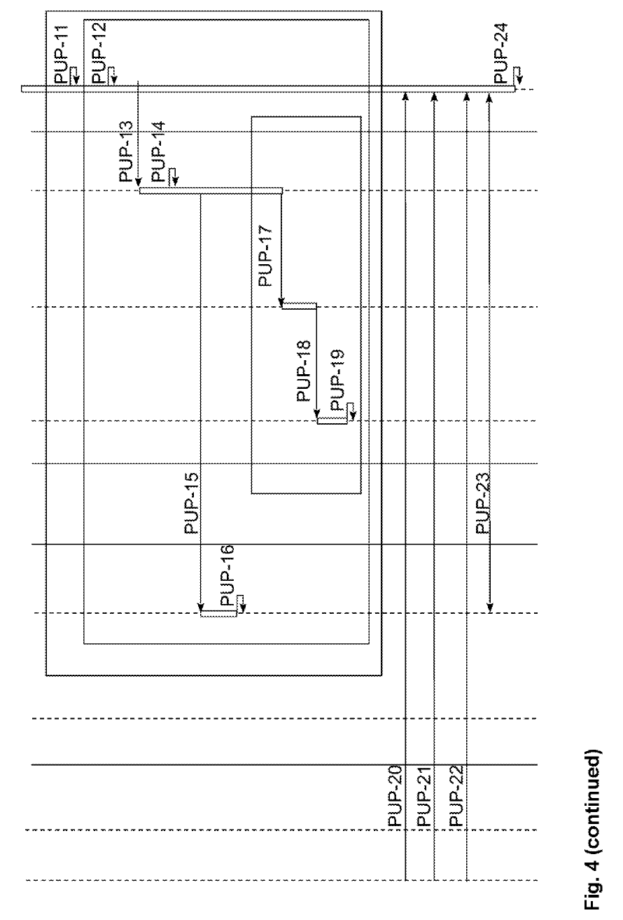

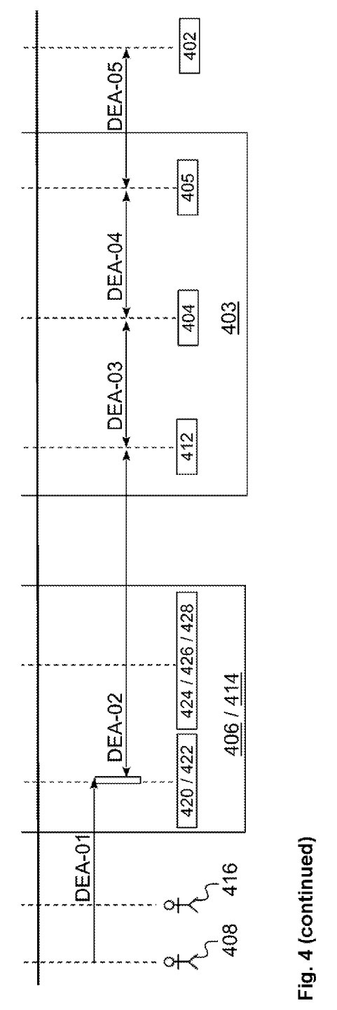

FIG. 4 illustrates, in the form of a schematic sequence diagram, a further exemplary embodiment of a method 400 for controlling an access to a motor vehicle 402, wherein a central vehicle producer server 404, a key tracking server (KTS) 405, and a service provider server 412 are present in a backend 403. The system 400 furthermore comprises a terminal 406 of an owner 408 of the vehicle 402. The terminal 406 comprises an app 420 and a secure element 424. The system 400 furthermore once again comprises a terminal 414 of an employee of the service provider having a service app 422 and a secure element 426. For reasons of clarity, only one terminal is indicated in FIG. 4, which alternatively either adopts the role of the terminal 406 having the app 420 and secure element 424 or the role of the terminal 414 having the app 422 and secure element 426.

The method 400 implements an (in particular server-based) delegated key sharing, wherein a transfer of risk is mapped clearly or unambiguously using technical measures. If an SBFD service is in use, i.e. if a corresponding shared key is active, and if this key is or was in contact with the vehicle 402, all other vehicle keys then no longer function, and specifically as long as the SBFD service is no longer active (i.e. no key shared thereby is still active) or was deleted.

The SBFD service can be provided for a single service appointment, or can be activated for a longer period of time, for example, in the context of a service contract which applies for several years, has an unlimited term, etc. The SBFD service grants a digital key, upon request, to an employee of the service provider. The employee uses this key when he or she takes care of the vehicle 402. The first contact with the key shared by the SBFD service automatically results in a temporary suspension or blocking of access authorizations (only control or driver authorization, or access and driver authorization) of all keys not shared by the SBFD service. The temporary blocking of the keys ends when all keys shared by the SBFD service are deleted or when the SBFD service itself is deleted.

One condition for the sequence described specifically hereinafter on the basis of FIG. 4 is that the customer of the service provider, i.e., the user 408, has stored a digital key for the vehicle 402 on the terminal 406, i.e. an owner key, or an administrator key.

The sequence begins with steps ACT-01 – ACT-05 with a service activation. In this case, the customer 408 or owner of the vehicle 402 performs a service activation, by means of which an authorization for key sharing is delegated to a service provider.

In step ACT-01, the customer 408 books the service, thus, for example, a repair shop appointment, by means of the application 420 on his or her terminal 406. The application 420 can be an application provided by the vehicle producer for a key management relating to the vehicle 402, or an application of the service provider, in which the customer 408 books the appointment, wherein this application also has to have an authorization to manage digital keys on the terminal 406. The booked service can comprise a service which was included, for example, upon the purchase of the vehicle 402, or the booking relates to a service purchased or to be purchased separately.

In steps ACT-02, ACT-03, ACT-04, and ACT-05, a service activation protocol runs between the application 406 and the service provider server 412, between the service provider server 412 and the central vehicle producer server 404, the central vehicle producer server 404 and the key tracking server 405, and the key tracking server 405 and the vehicle 402. The service activation is only indicated here; the details are familiar to a person skilled in the art.

After successful service activation, the customer 408 sees a key element which represents the activated service, for example, in the form of an icon, in a wallet app on the terminal 406, and in the vehicle 402.

The further sequence in steps KSR-01 – CKS-18 relates to a request for a shared key for the vehicle 402. In this case, an employee 416 of the service provider requests the key sharing.

In step KSR-01, the employee 416 requests the key sharing on the service app 422 of his or her terminal 414 for the vehicle 402. The terminal 414 can be a mobile device which the employee 416 has on his or her person during the work. Alternatively, the key sharing can also be requested by means of a PC (“personal computer”) having an NFC terminal and a smart card (instead of the secure element 426 of the terminal 414), wherein the sequence would be different in terms of the details than described hereinafter, but would lead to the same result.

In step KSR-02, the app 422 on the terminal 414 sends a request for the key sharing to the service provider server 412. The request can contain, among other things, a VIN (“Vehicle Identification Number”). The further sequence of the performance of the key sharing is partially shown in simplified form.

In a step SHA-01, the service provider server 412 sends a request for a key sharing URL to the central vehicle producer server 404. The request can contain a short name for the digital vehicle key (“digital key friendly name”). In step SHA-02, the central vehicle producer server 404 generates a sharing URL and stores this URL in assignment to the short name. In step SHA-03, the central vehicle producer server 404 returns the sharing URL to the service provider server 412. In step SHA-04, the service provider server 412 returns a push message having parameters for the specifically existing service or application case and the sharing URL to the service app 422.

In steps CKS-01 – CKS-18, the key sharing takes place as technically initiated by the receiver device 414 of the shared key. The sequence is shown in abbreviated form in FIG. 4. In step CKS-01, the sharing URL is called by the app 422. The call goes to the secure element 426. In steps CKS-02, CKS-04, and CKS-06, key sharing (for example, “Friend Key Sharing” according to CCC) runs between the secure element 426 of the terminal 414 and the central vehicle producer server 404, and between the central vehicle producer server 404 and the key tracking server 405 (wherein the key tracking server 405 initiates key tracking in step CKS-05), and between the key tracking server 405 and the vehicle 402. The secure element 426 generates a digital key here and outputs an endpoint certificate for the digital key in step CKS-03. In step CKS-07, the vehicle verifies attestation data and persists the digital key.

In a step CKS-08, the central vehicle producer server 404 gives an event message relating to a status of the key sharing to the service provider server 412. The service provider server 412 thereupon updates the status of the key sharing in step CKS-09. In step CKS-10, the service provider server 412 sends a push message to the service app 422 on the terminal 414 relating to a status of the key sharing.

Steps CKS-11 – CKS-14 relate to a preliminary notification with respect to the new key. In step CKS-11, the key tracking server 405 sends an event notification relating to the new key to the secure element 426. In step CKS-12, the secure element 426 updates the wallet. In step CKS-13, the central vehicle producer server 404 sends an event notification relating to the new key (preliminary, without confirmation by the vehicle 402) to the service provider server 412. In step CKS-14, the service provider server 412 performs an update relating to the notified new key (unconfirmed).

In step CKS-15, the vehicle 402 sends a message to the key tracking server 405 relating to a confirmation of the persisted key. Thereupon, in steps CKS-16 – CKS-18, an event notification relating to the new key takes place (final, i.e. with confirmation from the vehicle 402). In detail, the key tracking server 405 sends, in step CKS-16, an event notification relating to the new key (confirmed) to the central vehicle producer server 404. In step CKS-17, the central vehicle producer server 404 sends an event notification relating to the new key (confirmed) to the service provider server 412. In step CKS-18, the service provider server 412 performs an update relating to the new key (confirmed).

The key sharing is thus ended. The employee 416 has an active digital key on the terminal 414 (the terminal 414 can be a smart phone as stated, however, it could also be a smart card).

Steps EXS-01 – EXS-08 described hereinafter relate to the beginning of a service performance, for example a repair on the vehicle 402. The employee 416 performs the work on the vehicle 402.

In step EXS-01, the employee 416 approaches the vehicle 402. In step EXS-02, a standard transaction according to CCC runs between the secure memory 426 and the vehicle 402. The key shared by the SBFD service is detected, and thereupon the sequence takes place according to further steps EXS-03 – EXS-08. In step EXS-03, the vehicle 402 marks or identifies the SBFD service as “in performance” or the shared key as “in use”, or the like. This implicitly has the result that all (digital or nondigital) keys which were not shared by the SBFD service are blocked or suspended.

In step EXS-04, the vehicle sends a notification to the key tracking server 405, which transports a content that the SBFD service is “in performance”, or the like. In step EXS-05, the key tracking server 405 sends an event notification of the content that the SBFD service is “in performance” to the central vehicle producer server 404. In step EXS-06, the central vehicle producer server 404 updates the SBFD as “in performance”. In step EXS-07, the central vehicle producer server 404 sends an event notification to the service provider server 412 of the content that the SBFD service is “in performance”. In step EXS-08, the service provider server 412 updates the SBFD service as “in performance”. Therefore, all digital and nondigital keys of the customer 408 (including shared keys, if not shared by the SBFD service) are temporarily deactivated or blocked, as regards a driving authorization, or an access and driving authorization.

Following steps EXE-01 – EXE-024 relate to a performance of the service or booked task. During the performance, only employees of the service provider having keys shared by the SBFD service receive complete access to the vehicle 402. A driving authorization, and optionally an access authorization, of customer keys is deactivated during the performance of the task.

Steps EXE-01 – EXE-10 relate to a scenario in which the customer 408 (or family member, etc.) approaches with a digital vehicle key for the vehicle 402, wherein the key is an owner key, a key shared thereby (except for the SBFD on the service provider server 412), or a key also given with the vehicle 402 at the factory (for example, in the form of a key fob, smart card, etc.).

In step EXE-01, the customer 408 approaches the vehicle 402. Following steps EXE-02 – EXE-05 relate to a scenario in which the access and driving authorization are temporarily blocked. In step EXE-02, a standard transaction runs according to CCC between the vehicle 402 and the secure element 424 of the terminal 406. In step EXE-03, the vehicle 402 checks the SBFD service, and establishes that the service is “in performance”. In step EXE-04, the vehicle 402 checks that no active keys are present for the SBFD service, and establishes in this case that there is at least one active key. As a result, there is an error case of the CCC standard transaction, because the SBFD service is in performance and at least one key shared thereby is still active. Thereupon, in step EXE-05, opening of a door of the vehicle 402 is blocked, i.e. the customer 408 cannot open the door.

Steps EXE-06 – EXE-07 relate to an alternative to the scenario of steps EXE-02 – EXE-05, in which only a driving authorization is temporary. In step EXE-06, a standard transaction according to CCC runs between the vehicle 402 and the secure element 424 of the terminal 406. In step EXE-07, the customer 408 can thereupon open a vehicle door of the vehicle 402.

Steps EXE-08 – EXE-10 relate once again to alternative scenarios in which the vehicle 402 is unlocked or an access authorization is not blocked. In step EXE-08, the customer 408 enters the vehicle 402. In step EXE-09, the customer 408 presses a button in order to start the engine. Step EXE-10 relates to alternatives in which only a driving authorization, or an access and driving authorization, is temporarily blocked. In step EXE-10, a standard transaction is to run with an exchange of an immotoken (“immobilizer token”), but ends in an error situation because the SBFD service is in performance and at least one key shared thereby is still active.

Steps EXE-11 – EXE-18 relate to scenarios in which the customer 408 approaches the vehicle 402 with a classic key fob 428 (the box in FIG. 4, which previously represented the secure memory 424 or 426, is to represent the key fob 428 for steps EXE-11 – EXE-18, in order to keep FIG. 4 clear).

In step EXE-11, the customer 408 approaches the vehicle 402. Steps EXE-12 and EXE-13 relate to an alternative in which an access and driving authorization is temporarily blocked. In step EXE-12, a challenge-response method is performed between vehicle 402 and key fob 428, which ends with an error case: the SBFD service is in performance and at least one shared key is still active. Therefore, in step EXE-13, a vehicle door of the vehicle 402 does not open and the customer 408 cannot enter.

Steps EXE-14 and EXE-15 relate, in contrast to steps EXE-12 and EXE-13, an alternative in which only a driving authorization is temporarily blocked. Accordingly, in step EXE-14, a challenge-response method is performed between vehicle 402 and key fob 428, which runs successfully, and therefore, in step EXE-15, a door opens and the customer 408 can enter the vehicle 402.

Steps EXE-16 – EXE-18 relate once again to alternative scenarios in which the vehicle 402 is unlocked or access authorizations are provided. In step EXE-16, the customer 408 enters the vehicle 402. In step EXE-17, the customer 408 pushes a button in order to start the engine. Step EXE-18 relates to alternatives in which a driving authorization or an access and driving authorization is temporarily blocked. In step EXE-18, a challenge-response method is performed between vehicle 402 and key fob 428, which ends with an error case, because the SBFD service is in performance and at least one key shared thereby is still active. Starting of the engine is thereupon blocked.

Steps EXE-19 – EXE-25 relate to scenarios in which the employee 416 of the service provider approaches the vehicle 402 with the service provider key (or a further key shared therefrom) initially shared in steps CKS-01 – CKS-18.

In a step EXE-19, the employee 416 approaches the vehicle 402. Thereupon, in step EXE-20, a standard transaction according to CCC runs between the vehicle 402 and the secure memory 426 of the terminal 414 of the employee 416. In step EXE-21, a vehicle door can be opened by the employee 416. In step EXE-22, the employee 416 enters the vehicle 402. In step EXE-23, the employee 416 presses the starting button to start the engine. In step EXE-24, a successful standard transaction thereupon takes place between vehicle 402 and secure memory 426 of the terminal 414 with transfer of an immobilizer token. In a step EXE-25, the vehicle 402 starts an engine.

Steps EXF-01 – EXF-36 relate to an ending of the service performance. The employee 416 confirms a completion of the task; all keys shared by the SBFD service are thereupon deleted.

In step EXF-01, the employee 416 confirms the completion of the task via input in the service app 422 at his or her terminal 414. In an alternative, the input could also take place at a PC, service terminal, etc. if an NFC terminal is present there and a smartcard (instead of the secure memory 426 of the terminal 414). In step EXF-02, the service app 422 sends a request to the service provider server 412 for the purpose of informing that the task performance is ended. The request can contain, for example, a task number, performance ID, etc.

Following steps EXF-03 – EXF-021 relate to a deletion of all keys derived from the SBFD service. These steps represent the sequence in simplified form; the details are obvious to a person skilled in the art.

In step EXF-03, the service provider server 412 sends a request to the central vehicle producer server 404 relating to an ending of key sharing for the SBFD service. Following steps EXF-04 – EXF-021 are run through in the form of a loop for each directly or indirectly shared key of the SBFD service.

In step EXF-04, the central vehicle producer server 404 sends a request to end the relevant key to the key tracking server 405. The request contains, for example, a corresponding endpoint ending request. In step EXF-05, the key tracking server 405 ends the corresponding key. Depending on the specific application, this can either mean that the key is subjected to a soft delete, for example by default, i.e. is set to a status “extended” or the like, or that the key is subjected to a hard delete. In step EXF-06, the key tracking server 405 returns a success message as a result to the central vehicle producer server 404. In step EXF-07, the central vehicle producer server 404 returns a success message as a result to the service provider server 412. In step EXF-08, the service provider server 412 returns a success message as a result to the service app 422 on the terminal 414 of the employee 416.

In step EXF-09, the key tracking server 405 pushes a command to delete the corresponding key to the vehicle 402. Steps EXF-10 – EXF-14 relate to a preliminary notification (before the confirmation by the vehicle 402 that the key was deleted) that the corresponding key is in a delete state. In step EXF-10, the key tracking server 405 sends an event notification to the secure memory 426 which represents a content that the key is in a delete state. In step EXF-11, the secure memory 426 updates the wallet accordingly. In step EXF-12, the key tracking server 405 sends an event notification to the central vehicle producer server 404 of the content that the relevant key is in a delete state. In step EXF-13, the central vehicle producer server 404 sends an event notification to the service provider server 412 of the content that the relevant key is in a delete state. In step EXF-14, the service provider server 412 performs an update of the content that the key is in a delete state.

In step EXF-15, the vehicle 402 updates the relevant key, which is thereupon in the state “deleted” or the like. In step EXF-16, the vehicle 402 pushes a confirmation to the key tracking server 405. Steps EXF-17 – EXF-21 relate to an expansion of a notification confirmed by the motor vehicle 402 that the corresponding key is deleted. In step EXF-17, the key tracking server 405 sends an event notification to the secure memory 426 of the content that the key is deleted. In step EXF-18, the secure memory 426 updates the wallet accordingly. In step EXF-19, the key tracking server 405 sends an event notification to the central vehicle producer server 404 of the content that the relevant key is deleted. In step EXF-20, the central vehicle producer server 404 sends an event notification to the service provider server 412 of the content that the relevant key is deleted. In step EXF-21, the service provider 412 performs an update of the content that the key is deleted.

As an alternative or further option, which can be performed before, in parallel with, or after the deletion of the key or keys in steps EXF-01 – EXF-21, steps EXF-022 – EXF-36 relate to a status change of the SBFD service to the effect that the vehicle 402 is ready for a transfer of risk (i.e. transfer to the customer 408).

In step EXF-22, the employee 416 confirms a readiness for a transfer of risk to the customer by means of corresponding input in the service app 422 on his or her terminal 414. Depending on the details of the application, step EXF-22 can take place together with step EXF-01, so that, for example, only a single input is necessary at the service app 422. In step EXF-23, the service app 422 sends a request for information to the service provider server 412 that the test performance is ended. The request can contain, for example, a task number, a performance ID, etc.

In step EXF-24, the service provider server 412 sends a request of the content to the central vehicle producer server 404 that a flag is to be set with respect to the SBFD service with an indication or information “ready for transfer of risk” or the like. In step EXF-25, the vehicle producer server 404 sends a corresponding request to the key tracking server 405. In step EXF-26, the key tracking server 405 updates the SBFD service accordingly.

In step EXF-27, the key tracking server 405 returns a success message to the central vehicle producer server 404 as a result. In step EXF-28, the central vehicle producer server 404 returns a success message to the service provider server 412 as a result. In step EXF-29, the service provider server 412 performs an update of the content that the SBFD service is in the status “ready for transfer of risk”, wherein a confirmation is pending. In step EXF-30, the service provider server 412 returns a success message to the service app 422 as a result.

In step EXF-31, the central vehicle producer server 404 sends a command of the content to the vehicle 402 that the SBFD service is to be updated to the status “ready for transfer of risk”. In step EXF-32, the vehicle 402 updates the status of the SBFD service to “ready for transfer of risk”. In step EXF-33, the vehicle 402 sends a confirmation to the key tracking server 405.

Steps EXF-34 – EXF-36 relate to the distribution of a notification that the SBFD service (confirmed by the vehicle 402) is in the status “ready for transfer of risk”. In step EXF-34, the key tracking server 405 sends an event notification to the central vehicle producer server 404 of the content that the SBFD service confirms that it is in the state “ready for transfer of risk” or the like. In step EXF-35, the central vehicle producer server 404 sends an event notification to the service provider server 412 of the content that the SBFD service confirms that it is in the state “ready for transfer of risk”. In step EXF-36, the service provider server 412 updates the status of the SBFD service to “ready for transfer of risk (confirmed)”.

After ending the task performance, all keys shared by the SBFD service are therefore either in the state “extended” (as a stage of a multistage deletion method, wherein the key authorizations are still intact), or the keys are already finally deleted. The SBFD service is in a status “ready for transfer of risk”, wherein this transfer of risk to the customer 408 has not yet taken place.

Steps PUP-01 – PUP-024 relate to a transfer of the vehicle 402 to the customer 408 or an acceptance of the vehicle 402 by the customer 408 after the task performance. All keys shared from the SBFD service are either in the “extended” state or are already finally deleted. In the course of the transfer, the SBFD service is no longer in the state “ready for transfer of risk”. It is presumed by way of example that the customer 408 uses a digital key, thus an owner key, a key shared therefrom, or a key also provided with the vehicle 402 at the factory; if a key fob is used, however, a sequence does not differ in principle from the sequence described hereinafter.

In step PUP-01, the customer 408 approaches the vehicle 402. Steps PUP-02 – PUP-10 relate to a detection of a key shared by the SBFD service. In step PUP-02, a standard transaction runs between vehicle 402 and secure memory 424 in the terminal 406 of the customer 408. In step PUP-03, the vehicle 402 checks the SBFD service for a status “ready for transfer of risk”. If the status of the SBFD service were still “in processing”, as a result the key of the customer 408 would still be blocked. In step PUP-04, the vehicle 402 checks for the presence of shared keys of the SBFD service, i.e. no active keys are still to exist, or all keys shared from the SBFD service are either to be in a status “extended” or are to be finally deleted.

In step PUP-5, the SBFD service is identified as “not in processing” or the like or corresponding state or status information is set. This implicitly has the result that all vehicle keys which were not shared by the SBFD service are no longer blocked or suspended. In step PUP-06, the vehicle 402 sends a message to the key tracking server 405 which indicates that the SBFD service is “not in processing”. In step PUP-07, the key tracking server 405 sends an event notification of the content to the central vehicle producer server 404 that the SBFD service is “not in processing”. In step PUP-08, the central vehicle producer server 404 updates the status of the SBFD service as “not in processing”.

In step PUP-09, the central vehicle producer server 405 sends an event notification of the content to the service provider server 412 that the SBFD service is “not in processing”. In step PUP-10, the service provider server 412 updates the status of the SBFD service as “not in processing”.

Steps PUP-11 – PUP-19 relate to scenarios in which the vehicle 402 comes into contact with a normal digital vehicle key (not shared by the SBFD service) or a key fob. If keys shared by the SBFD service should still be in an “extended” state up to this point, the keys are now finally deleted, as was already described above with steps EXF-03 – EXF-21.

In step PUP-11, the vehicle 402 checks the presence of keys in the status “extended”. Steps PUP-12 – PUP-19 are run through in the form of a loop for each key which is in the status “extended” (thus not necessarily shared by the SBFD service). In step PUP-12, the vehicle deletes the correspondingly found key. In step PUP-13, the vehicle 402 pushes the status of the key to the key tracking server 405. In step PUP-14, the key tracking server 405 updates the status of the key as “deleted”. In step PUP-15, the key tracking server 405 sends an event notification to the secure memory 426 in the terminal 414 of the employee 416. In step PUP-16, the secure memory 426 updates the wallet accordingly.

Steps PUP-17 – PUP-19 specifically relate to the key of the SBFD service itself or directly/indirectly derived keys. In step PUP-17, the key tracking server 405 sends an event notification of the content to the central vehicle producer server 404 that the relevant key was deleted. In step PUP-18, the central vehicle producer server 404 sends a corresponding event notification to the service provider server 412. In step PUP-19, the service provider server 412 performs a corresponding update.

In a step PUP-20, the customer 408 can open a vehicle door of the vehicle 402. In a step PUP-21, the customer 408 enters the vehicle 402. In a step PUP-22, the customer 408 presses a start button for an engine of the vehicle 402. In step PUP-23, a standard transaction is performed between the vehicle 402 and the secure memory 424 of the terminal 406 of the customer or vehicle owner 408, in the course of which an immobilizer token changes from the secure memory 424 to the vehicle 402. In a step PUP-24, the vehicle 402 starts an engine.

Steps DEA-01 – DEA-05 relate to a deactivation of the service. The description is simplified here; the details are known to a person skilled in the art. In step DEA-01, the vehicle owner 408 causes a deactivation of the service by means of the service app 420 on his or her terminal 406 (this can take place in various ways). In each of steps DEA-02, DEA-03, DEA-04, and DEA-05, a service deactivation protocol is performed between the app 420 on the terminal 406 of the vehicle owner 408 and the service provider server 412, the service provider server 412 and the central vehicle producer server 404, the central vehicle producer server 404 and the key tracking server 405, and the key tracking server 405 and the vehicle 402. As a result, the service key element in the wallet of the terminal 406 and in the vehicle 402 is removed.

Embodiments of the invention propose technical measures in order to depict or technically emulate a transfer of risk in the motor vehicle, as specifically occurs, for example, during a repair shop visit, maintenance appointment, etc. and as occurs very generally when the owner or other user of the vehicle temporarily transfers the vehicle to a service provider so that it can perform work on the vehicle, move, take over, park, guard, etc. the vehicle on behalf of the owner.

Such a transfer of risk is generally connected to whether trust exists, even below a legal threshold with respect to liability, warranty, etc. More precisely, trust has to exist between the vehicle owner and further co-users (family, guests, etc.), on the one hand, and the service provider or the employees of the service, on the other hand. Questions of trust arise because a digital key can in principle be shared an arbitrary number of times; for example, the CCC has standardized such repeated sharing (“service in chain”). As a result, under some circumstances it is not entirely clear how many and which persons had or have access while the vehicle is not in the area of influence of the vehicle owner, but rather on a repair shop premises, a parking area or parking garage managed by a parking service, etc. Vice versa, the vehicle owner has no insight as to how many shared keys for his or her vehicle are in use at the service provider.

Embodiments of the invention avoid such unclear situations by means of technical measures. From transfer of risk to the service provider, only keys assigned to the service provider can exercise their access rights to the vehicle, while access rights of all other keys, including the owner key, temporarily cannot be exercised after the transfer of risk, i.e. the keys are blocked in their effect. In this way, it is very clearly implemented that the responsibility for the vehicle lies with the service provider.

Technical measures according to the invention begin automatically at the time of the specific transfer of risk, i.e. when an employee of the service provider first approaches the vehicle with a key, and also ends automatically when the risk is transferred back to the vehicle owner, i.e. when the vehicle owner approaches the vehicle with his or her key again for the first time after the end of the service. Such a behavior is comfortable, secure, and trustworthy for all participating parties, because no inputs are required at the terminals. Technical preparations such as providing the SBFD service can be linked, for example, with a booking, thus do not require additional actions by the customer. The service provider requests a shared key, this procedure is entrusted to the respective employee and can be linked with other actions. The employee indicates the service executed via his or her terminal so that a transfer of risk is prepared, and this procedure can also take place automatically and therefore comfortably if it is linked with actions which the employee also already had to carry out by this point in order to indicate a task as completed.

Embodiments of the invention offer further advantages with respect to routine considerations, such as an approach of blocking an owner key during a repair shop visit starting from a backend. This is because all keys derived therefrom would have to be blocked for this purpose (except for the keys for the service provider derived from the SBFD service), as well as all other vehicle keys including the digital keys, classic key fobs, etc. which are directly coupled at the factory. This is very complex with a large number of shared keys, and surprising for the user if granted keys in the wallet are often blocked and then unblocked again. Because such massive blocking is to be performed upon each appointment, communication networks are also loaded accordingly, up to hardware such as secure memories, etc. The latter can be embodied, for example, as FLASH memories; such memories age due to frequent write accesses, and this is advantageous in particular if the respective key is only blocked and then unblocked again without the key actually being used.

In contrast, according to the approach of the invention, there is no necessity to access numerous keys as a preventive measure, but rather only one key is blocked upon an access attempt. This approach is clear to the user, a load of communication networks is minimal, and a strain of hardware and secure memories of numerous devices is also avoided.

Embodiments of the invention can be configured flexibly so that, for example, only starting of the engine, driving, etc. is blocked, but the vehicle owner or his or her associates still retain access to the vehicle interior.

Embodiments of the invention can handle digital keys which are held, for example, on terminals such as smart phones, precisely like conventional key fogs, smartcards, and other HW tokens, and therefore the system behavior according to the invention is uniform and easily comprehensible from a user viewpoint or the viewpoint of the service provider and its customers.

Technical measures proposed according to the invention are capable of unambiguously establishing who has access to the vehicle at a given time, so that questions such as liability in case of damage can be unambiguously answered.

Measures according to the invention are capable of increasing a general level of trust in technologies for in particular server-based key sharing. In general, a level of trust in the practicality and security of digital vehicle keys, associated key management, etc. is increased, and this is of great importance with regard to the increasing distribution of digital vehicle keys.

Embodiments of the invention are generally applicable for commercial business models in which a customer books a service or a corresponding appointment and transfers his or her vehicle for work such as maintenance, repair, washing, cleaning, etc. Embodiments of the invention are therefore of commercial interest for vehicle producers, device producers, car sharing providers, third-party providers of services such as flat tire repair, parking services, etc. and all corresponding tier 1 suppliers with respect to digital keys, in particular vehicle keys.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

100 system

102 motor vehicle

104 backend server vehicle producer

106 terminal of the owner/customer

108 owner/customer

110 service provider

112 backend server of the service provider

114 employee of the service provider

116 terminal of the employee

118 owner key

120 vehicle support app

122 service app

124 transfer of risk/transfer to the service provider

126 transfer of risk/transfer/return to the owner

128 SBFD, SBFD service

130 service provider key

132 service activation

134 key sharing

136 triggering of the blocking effect

138 blocked access attempt

140 declaration of completion

142 setting of the task status and deletion of shared keys

200 system

202 motor vehicle, vehicle

204 vehicle-side backend server, vehicle producer server

210 service provider

212 service-side backend server, service provider server

214 terminal

218 owner key

222 service app

228 SBFD, SBFD service

230 service provider key

232 status information

300 method

302-326 steps of the method

330 method

332-342 steps of the method

360 method

362-366 steps of the method

380 method

382-386 steps of the method

400 method

402 motor vehicle

403 backend

404 central vehicle producer server

405 key tracking server

406 terminal of the customer

408 customer

412 service provider server

414 terminal of the employee

416 employee

420 vehicle support app

422 service app

424 secure memory of the terminal 406

426 secure memory of the terminal 414

428 key fob

ACT-01 – ACT-05 steps of the method

KSR-01 – KSR-02 steps of the method

SHA-01 – SHA-04 steps of the method

CKS-01 – CKS-18 steps of the method

EXE-01 – EXE-25 steps of the method

EXF-01 – EXF-36 steps of the method

PUP-01 – PUP-24 steps of the method

DEA-01 – DEA-05 steps of the method

What is claimed is:

1. A method for controlling an access to a motor vehicle, the method comprising:
detecting a service-related digital vehicle key; and,
in reaction to the detection, blocking the access to the motor vehicle using a further vehicle key not related to the service.

2. The method according to claim 1, wherein a blocked status is virtually implemented.

3. The method according to claim 1, further comprising:
in reaction to the detection, assigning, to the service, access-related information related to the blocking.

4. The method according to claim 3, wherein the blocking takes place based on a check of the access-related information.

5. The method according to claim 3, wherein the blocking takes place based on a check of whether the service-related digital vehicle key is active.

6. The method according to claim 1, further comprising:
upon a service activation, storing a server-based vehicle key in the motor vehicle; and
storing the service-related vehicle key shared from the server-based vehicle key.

7. The method according to claim 1, wherein the blocked access relates to an access to the motor vehicle or driving of the motor vehicle.

8. The method according to claim 1, further comprising:
receiving an indication relating to an ending of a service execution; and
updating access-related information based on the received indication.

9. The method according to claim 8, wherein the updated access-related information specifies that the motor vehicle is ready for a transfer of risk.

10. The method according to claim 8, further comprising:
detecting a vehicle key not related to the service;
in reaction to the detection, checking the access-related information; and
based on the check, permitting an access to the motor vehicle using the detected vehicle key.

11. The method according to claim 10, wherein the check indicates that no service-related vehicle keys are active.

12. A method for controlling an access to a motor vehicle, the method comprising:
upon a service activation, generating a server-based vehicle key for the motor vehicle;
initiating sharing of a service-related vehicle key from the generated server-based vehicle key;
receiving access-related information for the service relating to blocking an access to the motor vehicle using a further vehicle key not related to the service; and
storing the access-related information in an assignment to the service.

13. The method according to claim 12, further comprising:
receiving a request relating to ending a service execution; and
based on the received request, sending a request to assign information to the service that the motor vehicle is ready for a transfer of risk.

14. The method according to claim 12, further comprising:
determining that no service-related vehicle key is active; and
based on the determination, sending a request to assign information to the service that the motor vehicle is ready for a transfer of risk.

15. A method for controlling an access to a motor vehicle, the method comprising:
receiving a request with respect to a transfer of risk relating to the motor vehicle; and
based on the received request, sending a request to assign information to a service that the motor vehicle is ready for the transfer of risk.

16. The method according to claim 15, further comprising:
deleting all shared service-related vehicle keys.

17. A method for controlling an access to a motor vehicle, the method comprising:
sending a request for sharing of a service-related vehicle key from a server-based vehicle key for the motor vehicle; and
sending a request relating to ending a service execution, wherein the request comprises assigning information to the service that the motor vehicle is ready for a transfer of risk.

18. A motor vehicle configured to perform a method for controlling an access according to claim 1.

19. A backend server configured to perform a method for controlling an access to a motor vehicle according to claim 12.

20. A terminal configured to perform a method for controlling an access to a motor vehicle according to claim 17.

21. A system for controlling an access to a motor vehicle, comprising:
the motor vehicle;
a terminal, wherein an application of a producer of the motor vehicle for the access to the motor vehicle is installed on the terminal;
at least one backend server, which is operated by the producer of the motor vehicle, the at least one backend server being configured to:
generate, upon a service activation, a server-based vehicle key for the motor vehicle;
initiate sharing of a service-related vehicle key from the generated server-based vehicle key;
receive access-related information for the service relating to blocking an access to the motor vehicle using a further vehicle key not related to the service; and
store the access-related information in an assignment to the service.
